(19) United States
(12) Patent Application Publication
(10) Pub. No.: US 2016/0167755 A1
(43) Pub. Date: Jun. 16, 2016

(54) UNMANNED UNDERWATER VEHICLES, LOCATIONS OF THEIR DOCKING STATIONS, AND THEIR PROGRAMMED ROUTES

(71) Applicant: CONOCOPHILLIPS COMPANY, Houston, TX (US)

(72) Inventors: Khalid A. SOOFI, Katy, TX (US); Dominique P. BERTA, Flower Mound, TX (US)

(21) Appl. No.: 14/537,486

(22) Filed: Nov. 10, 2014

Related U.S. Application Data
(60) Provisional application No. 61/903,059, filed on Nov. 12, 2013.

(51) Int. Cl. B63G 8/00; G01S 15/88

(52) U.S. Cl. CPC B63G 8/001; G01S 15/88; B63G 2008/002; B63G 2008/008; B63G 2008/005

(57) ABSTRACT

A method deploys an unmanned underwater vehicle (UUV) configured to sense a property of an ice floe includes defining a sector of an ocean region having a potential for an ice floe where the sector has a first predicted path selected from a first plurality of predicted paths as determined by a first probability function. The method also includes placing a docking station for the UUV at a location in the sector where the location is determined to intersect with the first predicted path. The method further includes sending instructions having an estimated location of the ice floe to the UUV at the docking station instructing the UUV to sail to a second predicted path that is selected from a second plurality of predicted paths that are determined by a second probability function using the estimated location.

### PRIOR RELATED APPLICATIONS

This application is a non-provisional application which claims benefit under 35 USC §119(e) to U.S. Provisional Application Ser. No. 61/903,059 filed Nov. 12, 2013, entitled “OPTIMIZATION OF THE NUMBER OF UNMANNED UNDERWATER VEHICLES, LOCATIONS OF THEIR DOCKING STATIONS, AND THEIR PROGRAMMED ROUTES,” which is incorporated herein in its entirety.

### FIELD OF THE INVENTION

This invention relates to a method for selecting parameters associated with the deployment of unmanned underwater vehicles and, in particular, selecting the number of vehicles required for a mission, selecting the location of docking stations for the vehicles, and selecting the routes programmed into the vehicles.

### BACKGROUND OF THE INVENTION

As land based hydrocarbon reservoirs become depleted, reserves in more remote and hostile locations of the earth are being explored. Many of these new locations are marine based and include cold regions such as the Arctic and Antarctic regions. These regions can be very cold especially in the winter time. Cold temperature can cause the formation of sea ice and ice floes, which is sea ice that drifts due to ocean currents and wind. It is noted that in many regions such at the North Atlantic and the Baltic, sea floes are traditionally a seasonal event, appearing in winter and vanishing in warmer seasons.

Ice floes can have a dimension that ranges from tens of meters to several kilometers and an associated mass. Drifting sea ice with such a large mass can pose significant problems to hydrocarbon production platforms in those regions subjected to ice floes. Accordingly, there is a need to continuously monitor sea ice floes and to measure details such as their direction of movement, speed, thickness and thus their mass.

### SUMMARY OF THE INVENTION

In one embodiment, a method for deploying an unmanned underwater vehicle (UUV) configured to sense a property of an ice floe is disclosed. The method includes: defining a sector of an ocean region having a potential for an ice floe, the sector having a first predicted path selected from a first plurality of predicted paths as determined by a first probability function; placing a docking station for the UUV at a location in the sector, the location being determined to intersect with the first predicted path; and sending instructions that include an estimated location of the ice floe to the UUV at the docking station instructing the UUV to sail to a second predicted path that is selected from a second plurality of predicted paths that are determined by a second probability function using the estimated location.

### BRIEF DESCRIPTION OF THE DRAWINGS

The invention, together with further advantages thereof, may best be understood by reference to the following description taken in conjunction with the accompanying figures by way of example and not by way of limitation, in which:

FIG. 1 is an exemplary embodiment of a production platform in communication with an unmanned underwater vehicle that is configured to sense a thickness of the sea ice;

FIG. 2 depicts aspects of the production platform being surrounded by a secure zone, an alert zone, and a reconnaissance zone; and

FIG. 3 is one example of a flow chart for a method for determining a parameter for deployment of an unmanned underwater vehicle for monitoring an ice floe.

### DETAILED DESCRIPTION OF THE INVENTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the appended claims and their equivalents.

Disclosed are methods for determining one or more parameters for deploying a plurality of unmanned underwater vehicles (UUVs) in regions that are subject to sea ice floes. The UUVs are configured to sense an undersea characteristic of a sea ice floe and send related information to a nearby production platform in order to monitor and track the ice floe. Parameters for deployment include a number of UUVs required to monitor an area, location of a docking station for each UUV, and determination of a programmed route for each UUV to follow. Because the exact route that an ice floe may follow is unpredictable, a probability function is used to determine a most likely range of routes that the ice floe may follow and use this range of routes to program a route for each UUV.

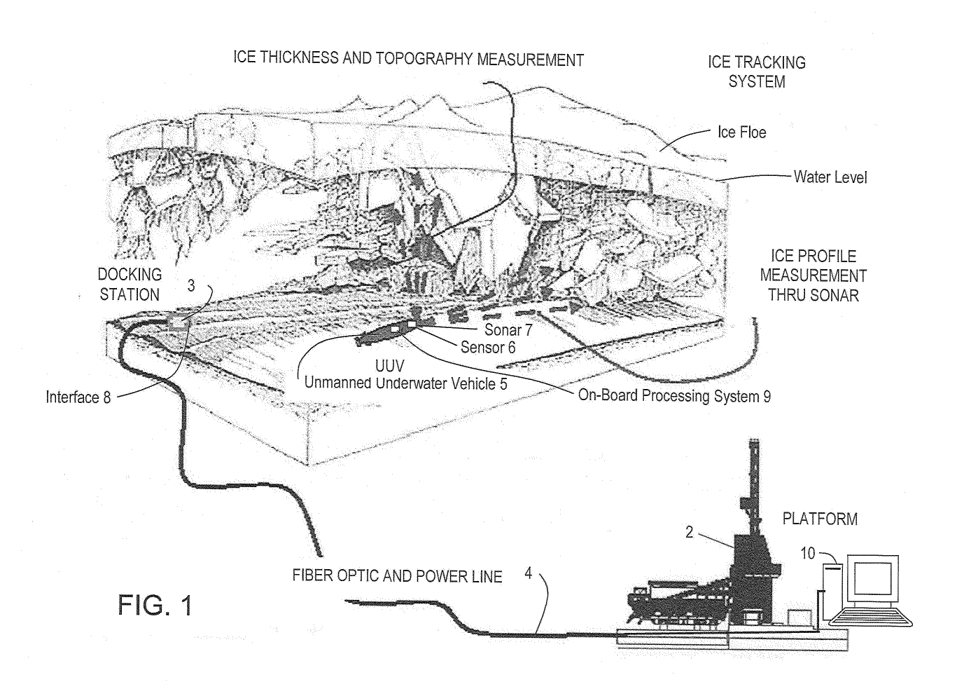

Referring now to FIG. 1, one embodiment of a marine production platform 2 in an ocean region subject to ice floes is illustrated. In the embodiment of FIG. 1, the production platform 2 is in communication with a docking station 3 using a cable 4 that includes a fiber optic and a power line. The term “production platform” includes any platform or vessel at sea whether stationary or mobile. The docking station 3 is configured to dock to an unmanned underwater vehicle (UUV) 5. The UUV 5 has a sensor 6 configured to sense distances to submerged parts of sea ice that may be directly above the UUV, in front of the UUV, or at some point in between. In one or more embodiments, the sensor 6 is a sonar 7. By measuring the distance to the sea ice above the UUV and subtracting that from the depth of the UUV, the thickness of the sea ice below sea water level at that point can be determined. In one or more embodiments, the UUV includes a pressure sensor in order to sense the depth of the UUV as it acquires sensed information. The UUV 5 is configured to dock with the docking station 3, which includes an interface 8 for coupling with the fiber optic to receive data from and download data to a processing system 10 disposed on the production platform 2. The interface also provides a connection with the power line to recharge one or more on-board batteries (not shown). An example of received data is a route that the UUV is to follow to monitor and track an ice floe. The route may provide for the UUV sailing back and forth under the ice floe to sense information or behind the ice floe if the ice floe moves away from the production platform. An example of downloaded data is sensed information such as ice floe thickness, horizontal or diagonal distance to an ice floe, and location of the UUV. The location can be an absolute location such as grid coordinates or a location relative to the production platform. The UUV 5 further includes an on-board processing system 9, which includes computer processing components, such as a processor, memory, storage, and interfaces, that allow the UUV 5 to: communicate with the processing system 10 at the production platform via the docking station, receive and store instructions (such as navigation instructions) from the processing system 10, process data obtained from an on-board sensor, calculate navigation routes, and generally operate the UUV 5.

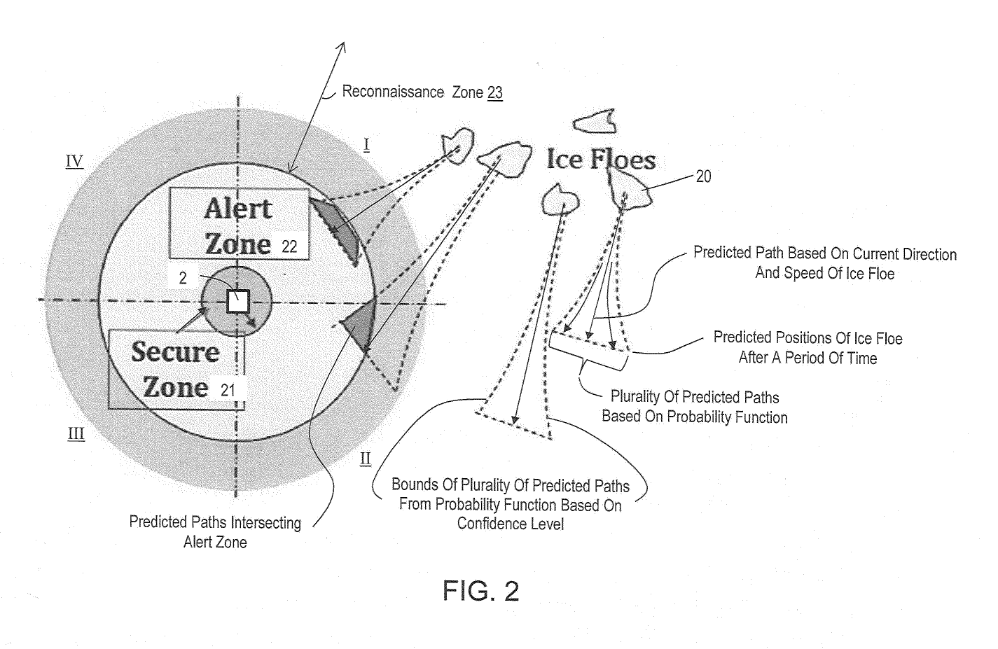

Referring now to FIG. 2, an aerial view of ice floes 20 near the production platform 2 is depicted. Immediately surrounding the platform is an area designated as a secure zone 21. Surrounding the secure zone 21 is an area designated as an alert zone 22. These zones are related to actions that may be taken if ice flows enter these areas. A reconnaissance zone 23 surrounds the alert zone 22. A plurality of UUVs and associated docking stations are disposed in the ocean near the platform and may be in the secure zone, the alert zone, or the reconnaissance zone depending on the size of these zones. Information about each of the ice floes such as their predicted track and size are needed before the ice floes enter the alert zone 22. Accordingly, the UUVs generally sail in the reconnaissance zone to obtain information about ice floes that may be headed into the alert zone. The UUVs may be alerted to the presence of ice floes by aerial reconnaissance aircraft or by orbiting satellites. These resources generally provide locations of any nearby ice floes that may affect the production platform. When these resources are not available, radar or lookouts on the production platform may identify nearby ice floes and their locations. Upon receiving notification of a nearby ice floe, one or more UUVs may be dispatched to the general or estimated location of the ice floe to obtain more exact information concerning the ice floe such as a more accurate location, speed, direction, size and mass.

Still referring to FIG. 2, each ice floe has a current direction and speed which may be used to predict a path over a certain time period if the direction and speed do not change. However, because of changing ocean currents and wind patterns, each ice floe may change direction and speed. Ice floes that may have originally appeared not to be of concern may shift direction to be on a path that intersects the alert zone. In order to predict a path for each ice floe, a probability function is employed to predict a plurality of paths and a corresponding probability. The probability function may be determined by historical data related to similar ice floes in the region. As an alternative, the probability function may be selected to be a normal or Gaussian distribution with the mean value being the current direction. The variance may be selected based on historical data or it may be equal to one for a standard normal distribution. Similarly, a probability function may be used to predict the speed of each ice floe. As with the direction probability function, the speed probability function may be based on historical data or a normal distribution may be selected with the current speed as the mean. For a selected probability function that has tails at the extreme ends such as the normal distribution, a confidence interval may be selected that provides a desired level of confidence in order to provide bounds limiting the spread of the plurality of predicted paths. For example, two standard deviations to each side of the mean provide a 95% confidence level.

Once a plurality of paths that an ice floe may follow is determined in accordance with a probability function, a UUV may be dispatched to intersect the path in the plurality that is closest to the alert zone in order to optimize the time available. When the UUV gets within sensor range of the ice floe, the UUV can start sensing properties of the ice floe by sailing in a back-and-forth pattern, which may be referred to as “mowing the lawn,” until the ice floe is completely mapped and sensed. Upon obtaining the desired information or if the on-board batteries start to deplete to a certain level, the UUV calculates a route back to the corresponding docking station from its current position. The current position of the UUV may be determined from an on-board inertial navigation system or by sensing its position relative to stationary acoustic navigation beacons (not shown). In one or more embodiments, the return route is a straight line in order to quickly return to the docking station. The UUV then travels to the docking station using the calculated route and docks. After docking, the UUV downloads sensed and processed data such as the direction, speed, size, and thickness of the ice floe. It can be appreciated that the total thickness and thus the mass of the ice floe may be calculated from the submerged profile of the ice floe using an isostasy method, based on the buoyancy of the ice floe.

In order to make the most efficient use of resources, the smallest number of UUVs that are required to explore or sense a certain area is determined based upon the capability of a UUV and the size of area to be sensed. The size of the area to be sensed may be narrowed down using a probability function of paths that sea floes have followed in the past within a desired confidence level. As with the above noted probability functions, this probability function may also be a normal distribution with a variance equal to one in one or more embodiments. Using this probability function, the most likely sub-area in the total area surrounding the production platform to have ice floes can be determined. Based on the size the most likely area, the area sensing rate of one UUV, and the time period required to sense the whole sub-area, the number of UUVs required to map and sense this area in that time period can be determined. It can be appreciated that a plurality of sectors may be defined in the ocean area about or around the production platform with a corresponding UUV assigned to each sector such that each UUV has the capability to sense the corresponding area in a defined time period. One example of sectors is illustrated in FIG. 2 where the area surrounding the platform 2 is divided into quadrants corresponding to Sectors I, II, III, and IV.

In that each UUV 5 has a corresponding docking station 3 to support it, each docking station may be located where ice floes are most likely to occur in accordance with the probability function for determining the most likely paths that ice floes will follow. By placing the docking stations at locations that predicted paths of ice floes will most likely intersect, the corresponding UUV will be able to react quickly to map and sense incoming ice floes before they enter the alert zone. In one or more embodiments, the docking stations are located in the vicinity of the boundary between the alert zone and the reconnaissance zone in order to be able to respond quickly to incoming ice floes and further track and sense any ice floes that may have entered the alert zone.

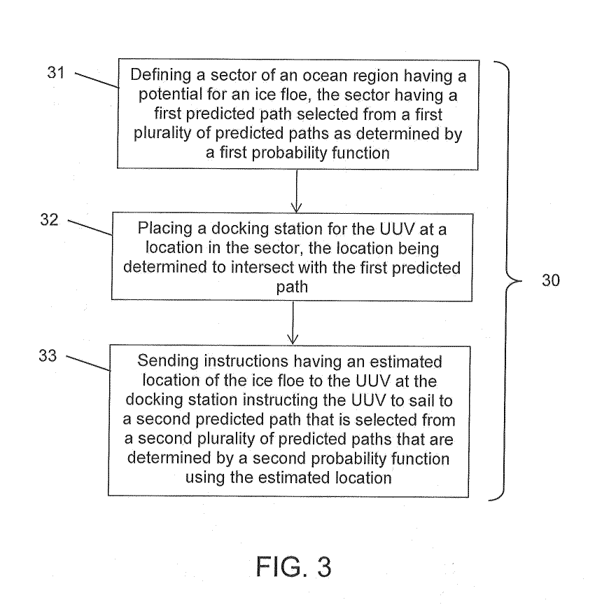

FIG. 3 is a flow chart for one example of a method 30 for deploying an unmanned underwater vehicle (UUV) configured to sense a property of an ice floe. Block 31 calls for defining a sector of an ocean region having a potential for an ice floe, the sector having a first predicted path selected from a first plurality of predicted paths as determined by a first probability function. Block 32 calls for placing a docking station for the UUV at a location in the sector, the location being determined to intersect with the first predicted path. Block 33 calls for sending instructions having an estimated location of the ice floe to the UUV at the docking station instructing the UUV to sail to a second predicted path that is selected from a second plurality of predicted paths that are determined by a second probability function using the estimated location.

The method 30 may also include (a) sailing the UUV to a point on the second predicted path; (b) sailing the UUV according a selected navigation pattern after reaching the point on the second selected path; and (c) sensing a property of the ice floe using a sensor on the UUV as the UUV follows the navigation pattern. The term “sailing” relates to the UUV moving underwater such as in one example moving underneath an ice floe. The method 30 may further include calculating a return route to the docking station using an on-board processor after completion of sensing the property. In one or more embodiments, the return route is a straight line on order to conserve batter power. The method 30 may further include sailing the UUV to the docking station according to the return route and docking with the docking station. The method 30 may further include downloading sensed information via an interface at the docking station to a processing system on a production platform. The sensed information may include ice floe movement direction, ice floe movement speed, ice floe size, ice floe undersea thickness, and ice floe mass as calculated from the ice floe undersea thickness.

In support of the teachings herein, various analysis components may be used, including a digital and/or an analog system. For example, the on-board processing system 9, the platform processing system 10, the UUV 5 may include digital and/or analog systems. The system may have components such as a processor, storage media, memory, input, output, communications link (wired, wireless, optical or other), user interfaces, display, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” are used to distinguish elements and do not denote a particular order.

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

What is claimed is:

1. A method for deploying an unmanned underwater vehicle (UUV) configured to sense a property of an ice floe, the method comprising:
defining a sector of an ocean region having a potential for an ice floe, the sector having a first predicted path selected from a first plurality of predicted paths as determined by a first probability function;
placing a docking station for the UUV at a location in the sector, the location being determined to intersect with the first predicted path; and
sending instructions comprising an estimated location of the ice floe to the UUV at the docking station instructing the UUV to sail to a second predicted path that is selected from a second plurality of predicted paths that are determined by a second probability function using the estimated location.

2. The method according to claim 1, further comprising:
sailing the UUV to a point on the second predicted path;
sailing the UUV according a selected navigation pattern after reaching the point on the second selected path; and
sensing a property of the ice floe using a sensor on the UUV as the UUV follows the navigation pattern.

3. The method according to claim 2, wherein the selected navigation pattern includes back and forth directions that are offset from one another.

4. The method according to claim 2, further comprising calculating a return route to the docking station using an on-board processor after completion of sensing the property.

5. The method according to claim 4, wherein the return route is a straight line to the docking station.

6. The method according to claim 4, further comprising sailing the UUV to the docking station according to the return route and docking with the docking station;

7. The method according to claim 6, further comprising downloading sensed information via an interface at the docking station to a processing system on a production platform.

8. The method according to claim 7, wherein the sensed information comprises at least one selection from a group consisting of ice floe movement direction, ice floe movement speed, ice floe size, ice floe undersea thickness, and ice floe mass.

9. The method according to claim 1, wherein the sector defines a total area that can be sensed by the UUV over a defined time period.

10. The method according to claim 1, wherein the UUV comprises a plurality of UUVs.

11. The method according to claim 10, wherein the sector comprises a plurality of sectors with each UUV in the plurality of UUVs being assigned to one corresponding sector in the plurality of sectors.

12. The method according to claim 1, wherein the first probability function is a normal distribution.

13. The method according to claim 1, wherein the first plurality of predicted paths is determined from historical data about ice floes in the ocean region.

14. The method according to claim 1, wherein the first predicted path has a highest probability among the predicted paths in the first plurality of predicted paths.

15. The method according to claim 1, wherein the second probability function is a normal distribution.

16. The method according to claim 1, further comprising receiving the estimated location.

17. The method according to claim 16, wherein the estimated location is received from an aerial or orbital surveillance system.

18. The method according to claim 1, wherein the UUV comprises a sensor configured to sense a property of the ice floe.

19. The method according to claim 18, wherein the sensor is a sonar device.

20. The method according to claim 1, wherein the UUV is configured to calculate a mass of the ice floe using a sensed undersea thickness of the ice floe.
